(19) United States
(12) Patent Application Publication
(10) Pub. No.: US 2011/0208599 A1
(43) Pub. Date: Aug. 25, 2011

(54) MOBILE MARKETING AND TARGETED CONTENT DELIVERY TO MOBILE DEVICES

(75) Inventors: Anandamoy Sen, Poway, CA (US); Partha S. Dey, San Diego, CA (US); Vamsi Sata, Boise, ID (US)

(73) Assignee: Zeenook, Inc., El Cajon, CA (US)

(21) Appl. No.: 12/947,791

(22) Filed: Nov. 16, 2010

Related U.S. Application Data
(60) Provisional application No. 61/261,666, filed on Nov. 16, 2009.

(51) Int. Cl. G06Q 30/00

(52) U.S. Cl. 705/16

(57) ABSTRACT

A mobile marketing system comprising a point of sale terminal configured to record data relating to purchasing activity, a mobile communication device in communication with the point of sale terminal, the mobile communication device containing a mobile device application configured to obtain data containing identifying information relating to a merchant, and a server providing the data containing identification information and storing the data relating to purchasing activity.

### CROSS-REFERENCE TO RELATED APPLICATIONS

This application claims priority to U.S. Provisional Patent Application Ser. No. 61/261,666, filed Nov. 16, 2009, which is incorporated by reference herein in its entirety.

### TECHNICAL FIELD

The subject matter described herein relates to mobile marketing and marketing content delivery, for example related to executing point of sale and point of experience transactions using a consumer's mobile device.

### SUMMARY

The current subject matter can provide an efficient and unique framework for marketing and for enabling point of sale transactions to be completed using a customer's mobile communication device. An end to end solution, exemplary implementations of which are described below, can enrich the customer experience by providing features that can include, but are not limited to, video content delivery, coupon delivery based on purchase history and preferences, coupon bidding, wireless transfer of receipts, soliciting deals with multiple merchants and shopping list management with minimal human intervention. The market potential of merchants and the efficiency of their marketing methodologies can both be increased.

According to various implementations of the current subject matter, software and/or hardware modules can be used to enrich the marketing experience of one or more merchants and the shopping experience of one or more consumers or users. A mobile device application, also described as “Penguin” throughout this disclosure, can be used on smart phones and be capable of different functions. A server P can be the service infrastructure providing services to the mobile device application (Penguin) and to the consumer/user of the mobile device application and the merchants. Along with all capabilities of a standard barcode scanner, device W can also be capable of interacting with mobile devices in the vicinity. The device W can also provide communication and data capture capabilities. A Point of Experience Terminal (PoET) can be used in accordance with a system and/or method according to an implementation of the current subject matter as a Point of Sale (POS) terminal. A point of presence/helper device, also labeled as “LaBox” throughout this disclosure can be used at a merchant premises as a functional aide.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

In exemplary embodiments, a mobile marketing system comprises a point of sale terminal configured to record data relating to purchasing activity, a mobile communication device in communication with the point of sale terminal, the mobile communication device containing a mobile device application configured to obtain data containing identifying information relating to a merchant, and a server providing the data containing identification information and storing the data relating to purchasing activity.

In exemplary embodiments, the point of sale device may be a merchant device. The mobile communication device may contain an identification code, and the merchant device reads the identification code to authenticate a user of the mobile communication device. The merchant device scans transaction data including product identification codes purchased by a user and sends the transaction data to the mobile device application. The mobile device application may prompt a user of the mobile communication device when the user is in proximity of a point of sale terminal. The system may further comprise integration with a merchant backend server.

In exemplary embodiments, the server provides one or more of user registration services, user account maintenance services, user account management services, and content management services. The content management service enables transmission of marketing messages. In exemplary embodiments, the server captures one or more of user purchase preference data, coupon usage data, and bidding pattern data. The system may further comprise a positioning system in wireless communication with the mobile device application.

Exemplary embodiments include a content distribution system comprising one or more scanners, a point of experience terminal in communication with the one or more scanners, the point of experience terminal authenticating users of a mobile device application, receiving point of sale activity data from the mobile device application, and recording transaction data based upon the point of sale activity data, and a server in communication with the point of experience terminal, the server being configured to store one or more of: the point of sale activity data and the transaction data.

In exemplary embodiments, the scanners comprise one or more of a handheld barcode scanner, a bed barcode scanner, and an RFID scanner. The point of experience terminal may be in communication with checkout hardware, and the checkout hardware may comprise one or more of a credit card transaction system, a cash draw, a receipt printer and a pin pad with integrated card swipe. The system may further comprise a merchant backend support terminal. The system may further comprise a helper connectivity device.

Exemplary embodiments include a method of mobile marketing, comprising transmitting a signal containing identification data for a consumer, authenticating the identification data, initiating recording of point of sale terminal activity data including purchase data, and transmitting the point of sale terminal activity data to a mobile device application. The method may further comprise transmitting a signal containing data relating to a point of sale terminal in close proximity to a user to the mobile device application. The method may further comprise continuously polling a mobile communication device for point of sale terminal activity data. The method may further comprise continuously transmitting point of sale terminal activity record to a mobile device application.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows two flow charts illustrating a method from a customer and a merchant perspective;

FIG. 2 shows a diagram of interactions between system components;

FIG. 3 shows a diagram of interactions between system components including a point of experience terminal;

FIG. 4 shows a protocol communication diagram;

FIG. 5 shows a block level service structure diagram of a system including Server P;

FIG. 6 shows a call flow diagram for a service lookup protocol of communication between a mobile device application and Server P;

FIG. 7 shows a call flow diagram for registration and authentication services by Server P;

FIG. 8 shows a call flow diagram for content distribution services by Server P;

FIG. 9 shows a block level service structure diagram of a system including a Device W;

FIG. 10 shows a call flow diagram for generic communication flow involving Device W;

FIG. 11 shows a call flow diagram for mobile device application-Device W communication flow involving an Apple IPhone;

FIG. 12 shows a call flow diagram for identification and authentication of a mobile device application by a Device W;

FIG. 13 shows a call flow diagram for transaction capture using a pull model;

FIG. 14 shows a call flow diagram for transaction capture using a push model

FIG. 15 shows a block level service structure diagram of a system including PoET infrastructure;

FIG. 16 shows a call flow diagram for location based surveys;

FIG. 17 shows a call flow diagram for merchant hosted auctions;

FIG. 18 shows a call flow diagram for consumer hosted “looking for” services;

FIG. 19 shows a call flow diagram for consumer list management services;

FIG. 20 shows a system block diagram for an overall use case;

FIG. 21 shows a system block diagram for an interaction between a point of service terminal and mobile phone using a device W;

FIG. 22 shows a system block diagram for transaction activity between a point of service terminal and mobile phone using a device W;

FIG. 23 shows a system block diagram illustrating possible interfaces for a device W;

FIG. 24 shows a protocol stack diagram for a service oriented architecture;

FIG. 25 shows a block diagram of a computer system;

FIG. 26 shows a block diagram of internal architecture of a computer system; and

FIG. 27 shows architecture of a Device-W.

When practical, similar reference numbers denote similar structures, features, or elements.

### DETAILED DESCRIPTION

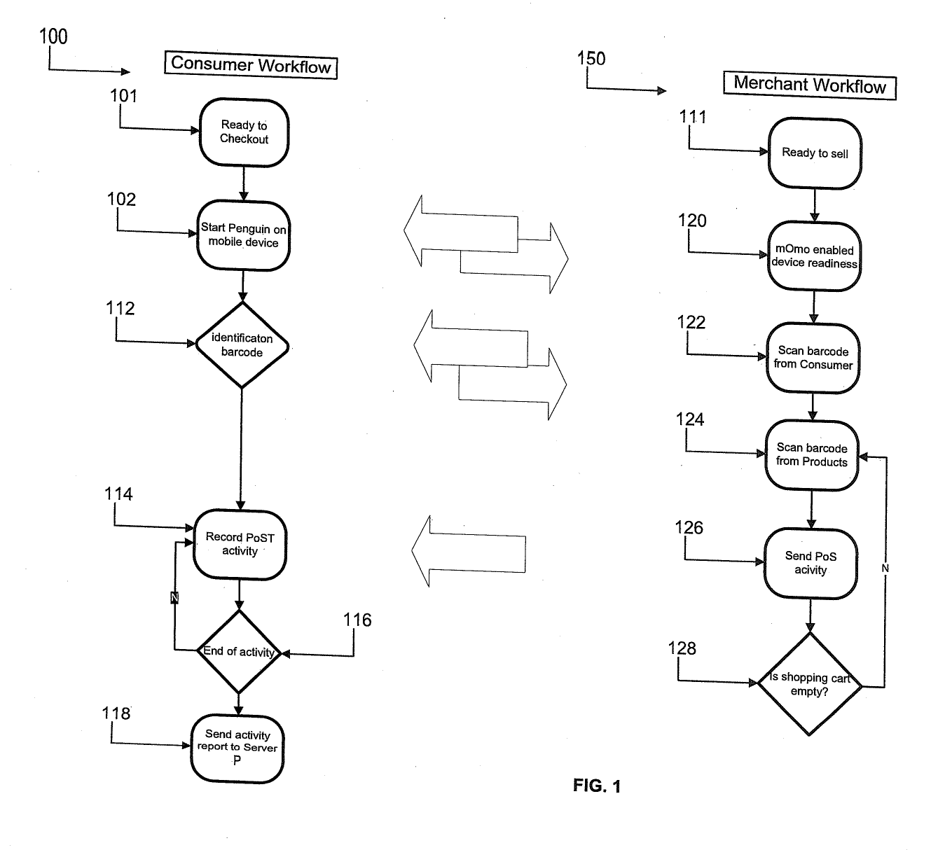

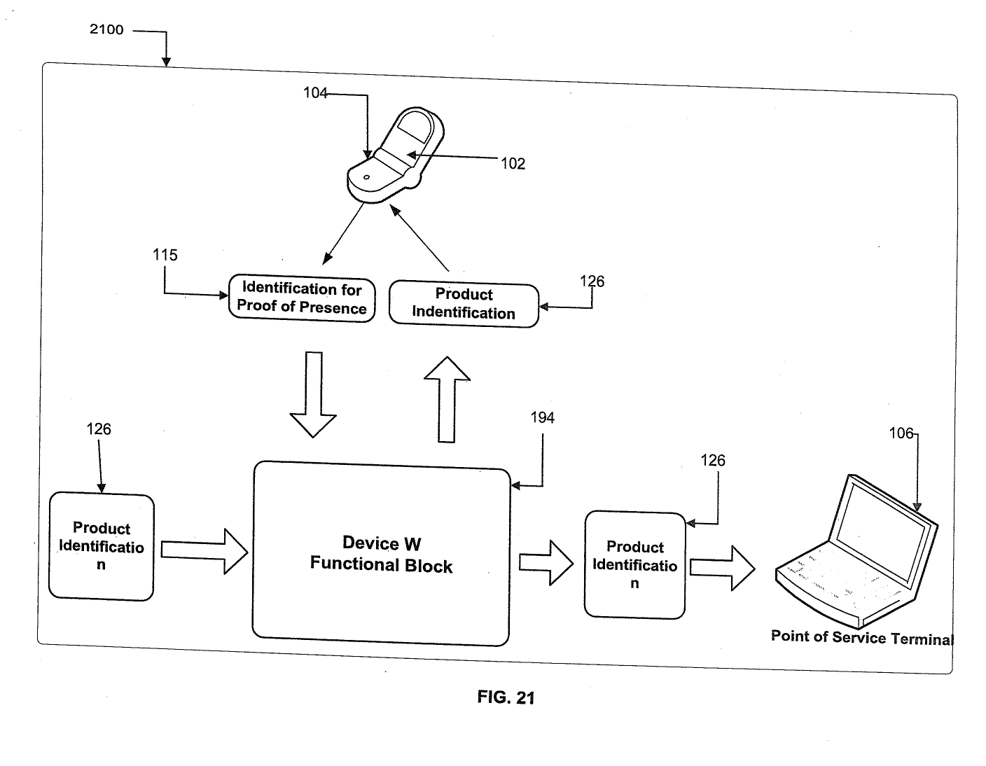

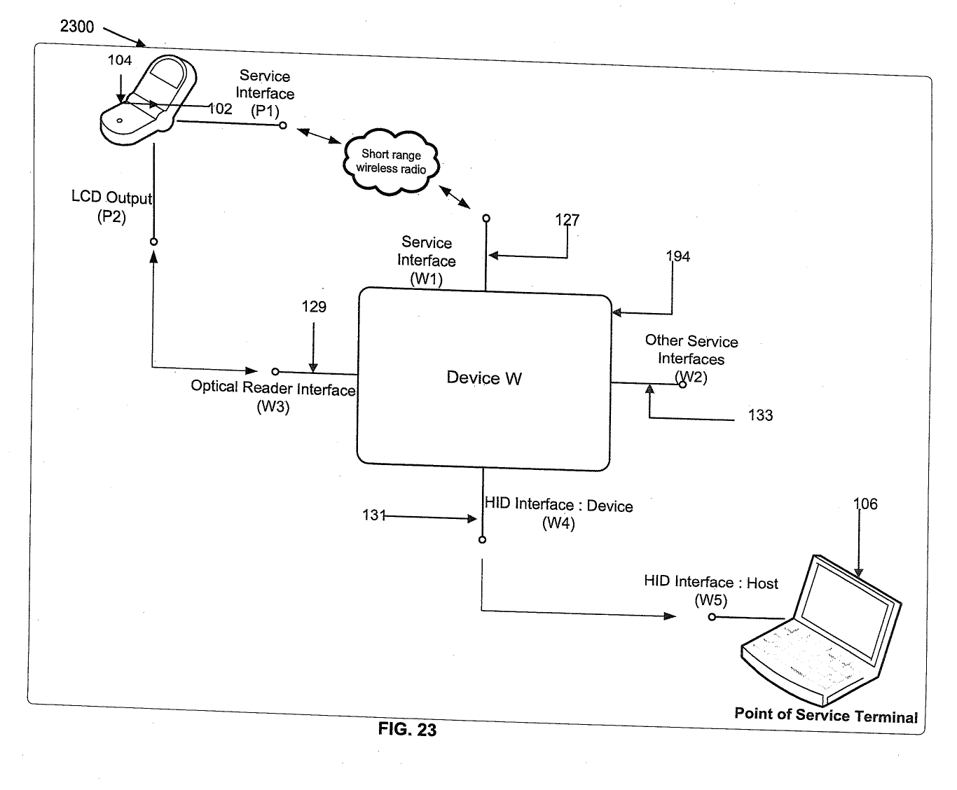

FIG. 1 shows two flow charts 100 and 150 illustrating merchant and consumer workflows in conjunction with each other according to an implementation. As shown in the consumer workflow 100, when a consumer completes shopping and is ready to checkout 101, he or she can launch a mobile device application 102 (“Penguin” in the figures) on a mobile communication device 104 such as a cellular phone, a smart phone, a personal data assistant, or the like, which communicates via an LCD output 141 (see FIG. 23). The mobile device application 102 then attains the nearest terminal 106 for the merchant 113 and obtains a relevant token from the server P 108. This information, in addition to the Local Terminal Identification Number (LTIN) 110, can be used to generate an identification barcode 112, which can be a barcode or other type of coding of information relevant to the purchase, as also shown in FIG. 21. Once the consumer is successfully authenticated, a POS terminal activity 116 (e.g., purchase activity) recording is initiated 114. The POS terminal recording can continue until the end of purchase activity 116 in an iterative loop. Upon the successful completion of the POS terminal recording, the data can be shared 118 with Server P 108 if the consumer is willing to do so.

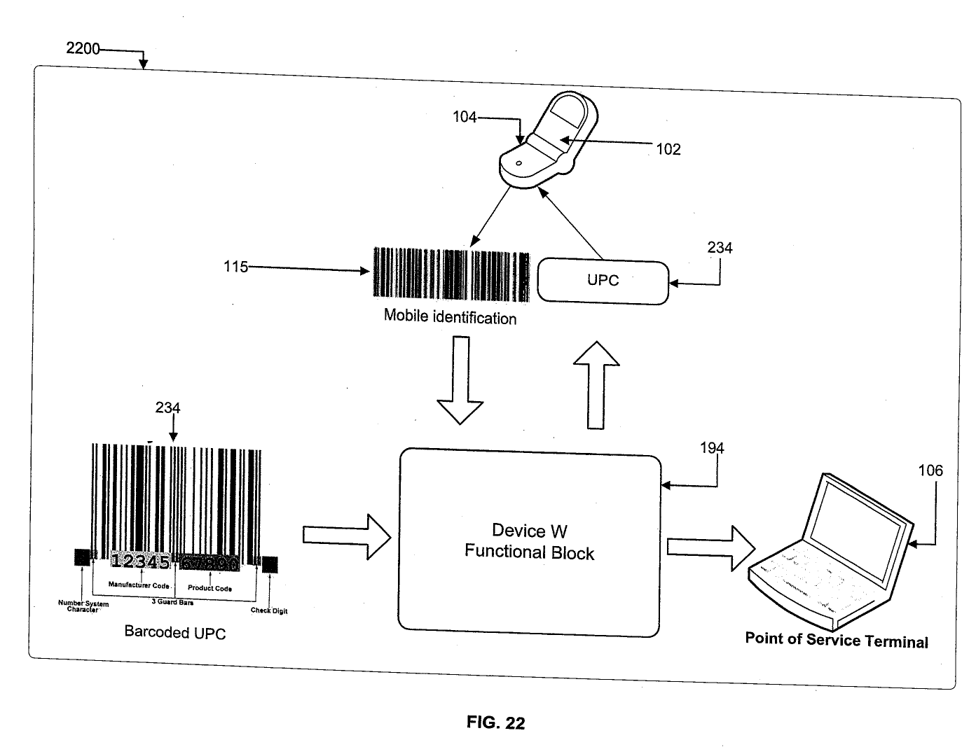

The consumer flow is well complemented by the merchant flow 150. Activation of a point of sale merchant device 120 (“momo enabled device” in the figures) to a ready state 111 prepares the merchant to perform a sale. As shown in FIGS. 1 and 21, when the consumer presents an identification barcode 112, this barcode is read 122 by the merchant 113 to authenticate the consumer for proof of presence 115. Once the authentication is finished, the merchant scans the barcodes of different products 124 purchased by the consumer and sends the product data 126 to the consumer's mobile device application (Penguin) 102. This module repeats itself until the customer shopping cart is empty 128. The user and barcode 112 scanning and identification process is shown in more detail in FIGS. 21 and 22.

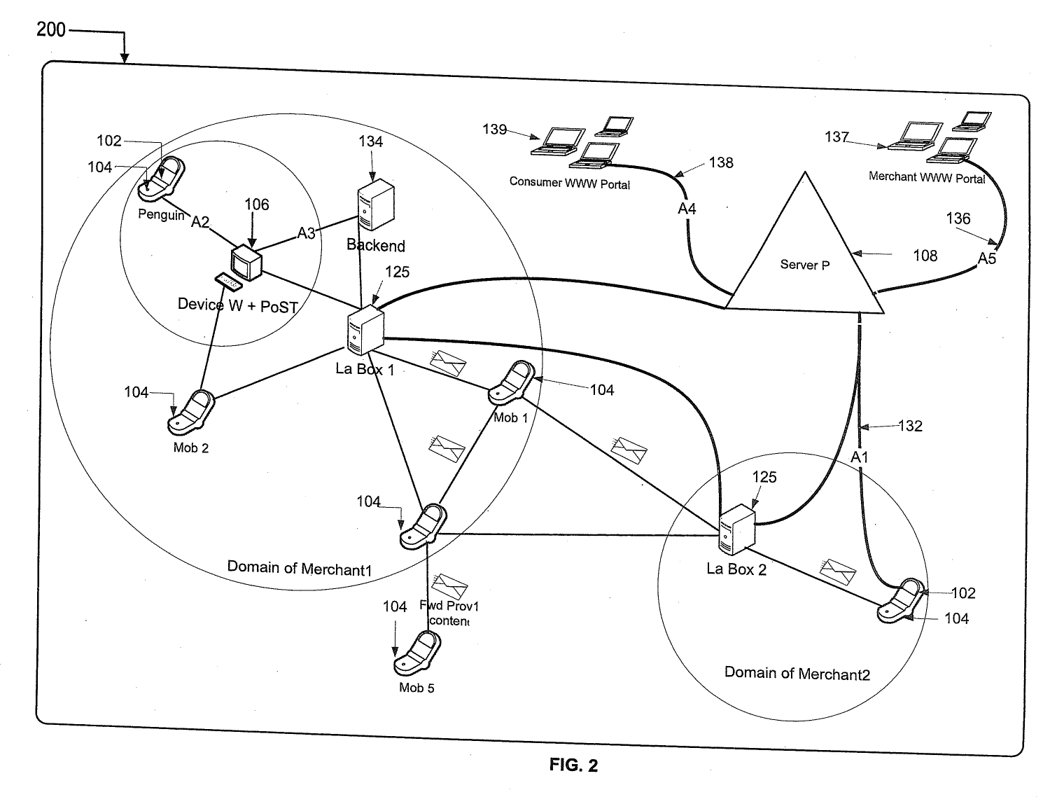

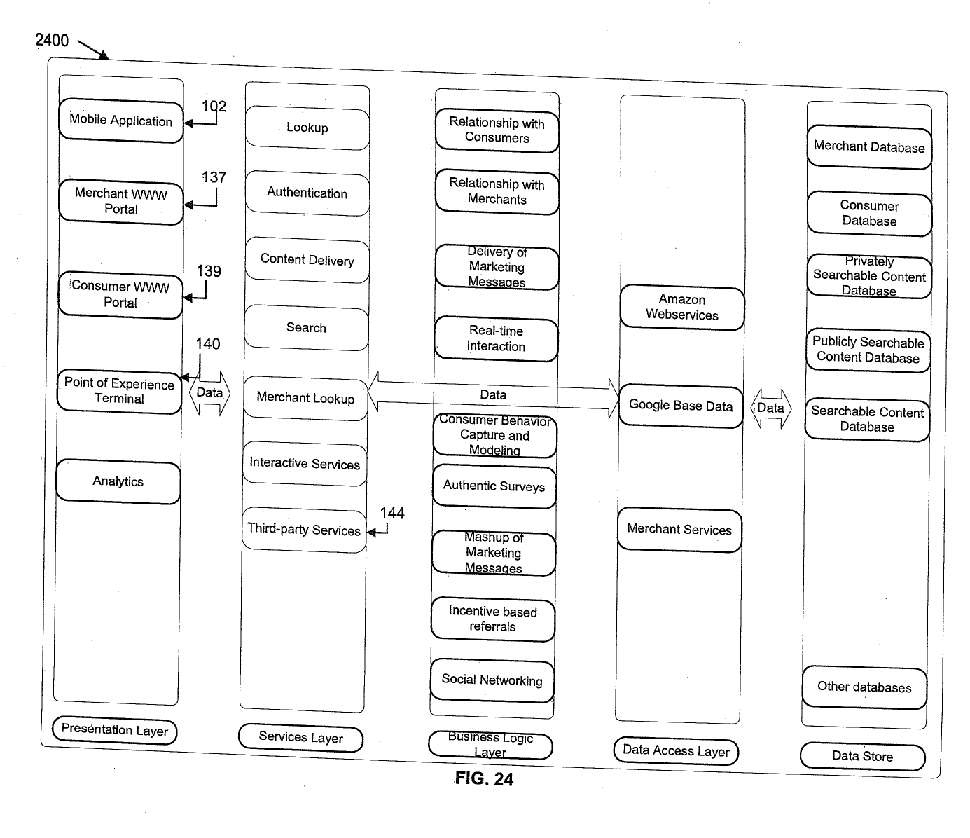

FIG. 2 shows a diagram of a system 200 with various components interacting to provide a unique approach for efficient mobile marketing, and FIG. 24 shows a block level view of how the various data are moving in an embodiment of the system 2400, including the features and actions of the system presentation, services, business logic and data access layers. A mobile device application 102 (Penguin) prompts the consumer when the consumer is in proximity of an enabled POS terminal 106. For a consumer's first use of the system 200, the mobile device application 102 can display a registration menu 130, for example in a pop-up menu. The consumer provides any required information and the information is sent to and stored in a machine-readable storage medium at Server P 108 (A1). Further interactions between the mobile device application 102 (Penguin) and POS (A2) terminal 106 are preceded by consumer authentication. The POS transactions can be recorded and transmitted to the mobile device application 102 (Penguin). If the consumer wishes to share his or her purchase activity data 132 with the system, the data can be sent to Server P 108 over A1. The POS terminal 106 can be capable of communicating with a merchant backend server 134 (A3). The functions performed by the backend server 134 are explained in more detail below. Server P 108 has the capability to communicate information such as data containing identifying information 136 relating to the merchant and/or data containing identification information 138 relating to a user with consumers and merchants, respectively, using a network such as the Internet, the World Wide Web, or some other wide or local area network via one or more portals, such as a consumer portal 139 (A4) and/or a merchant portal 137 (A5). Merchants can be able to host auctions, surveys etc on Server P using the web portals. Server P can provide a variety of services, both third party and other services which are discussed in more detail in the vertical applications section.

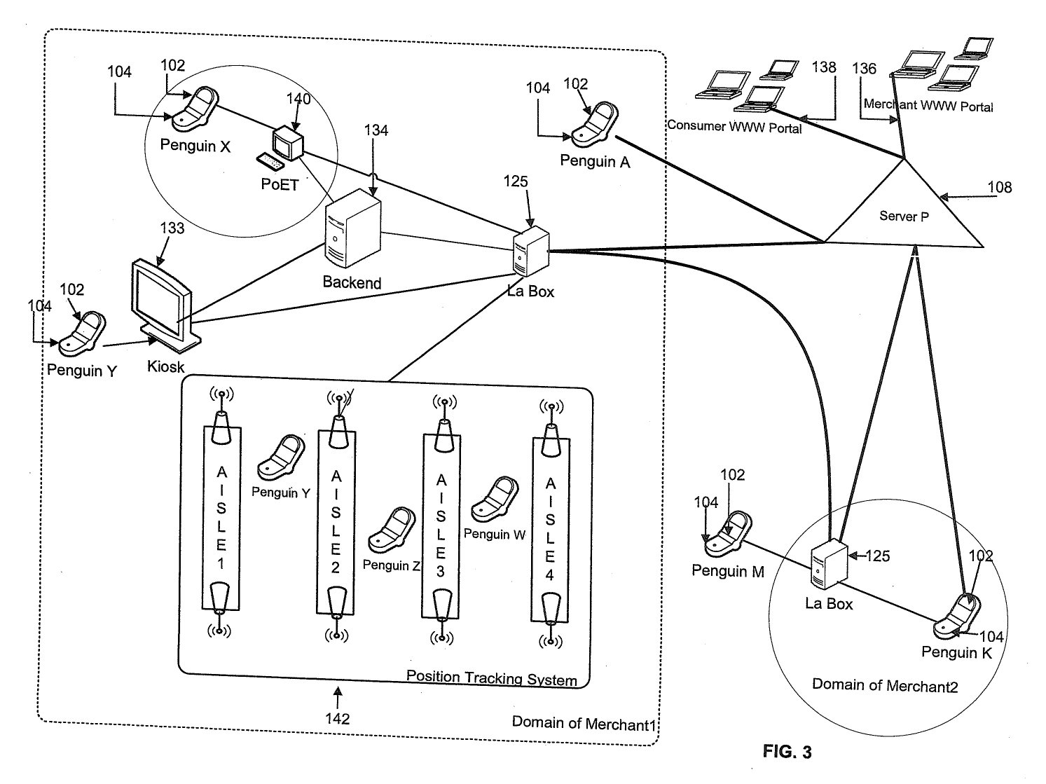

As shown, e.g., in FIGS. 2 and 3, LaBox 125 is a point of presence/helper connectivity device in the ecosystem consisting of PoS, Device-W, Penguin, Patrons and Merchants. LaBox 125 helps the entities of the eco-system communicate with each other as required by the application at hand. LaBox 125 exposes interfaces, both wireless and wired, to entities of the ecosystem. This is a device with extensible configuration that adapts to the application at hand.

FIG. 3 shows the system level interactions of various components of a content distribution system 300 in a configuration in which the Device W is replaced by PoET 140 (Point of Experience Terminal) which is another kind of POS Terminal. A PoET 140 can have similar capabilities as Device W and the system level interaction between the components can remain similar to the previous figure. FIG. 3 also shows a position tracking system 142, which can be a part of a PoET 140. The uses and applications of Kiosk services 133 and a position tracking system 142 as shown in FIG. 3 are discussed in greater detail below.

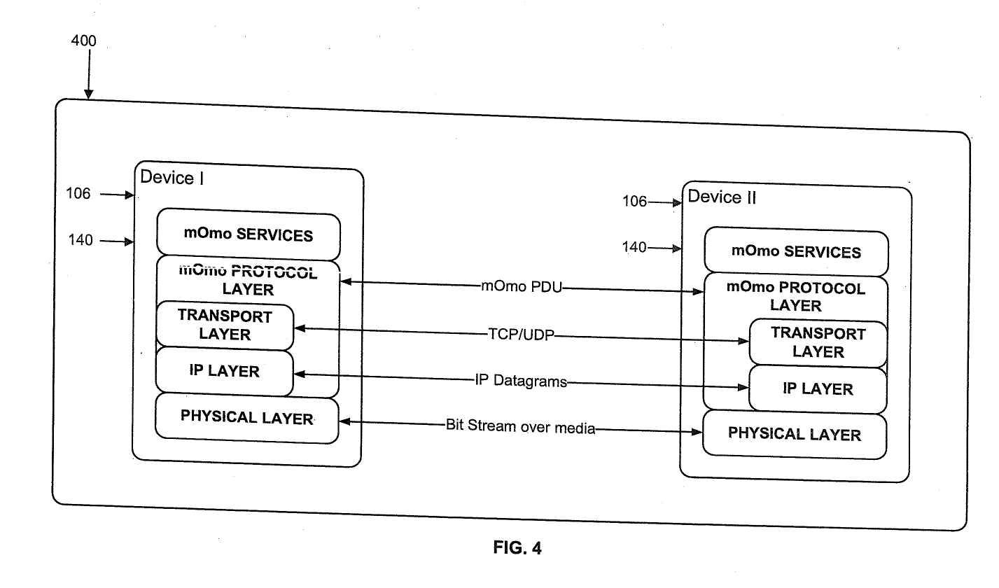

FIG. 4 is a protocol stack diagram illustrating communication between two POS or PoET devices or between any two devices described herein as components of a system 400 in accordance with an implementation of the current subject matter. As shown in FIG. 4, the protocol layer can be able to communicate with the Transport, IP, or Physical layers.

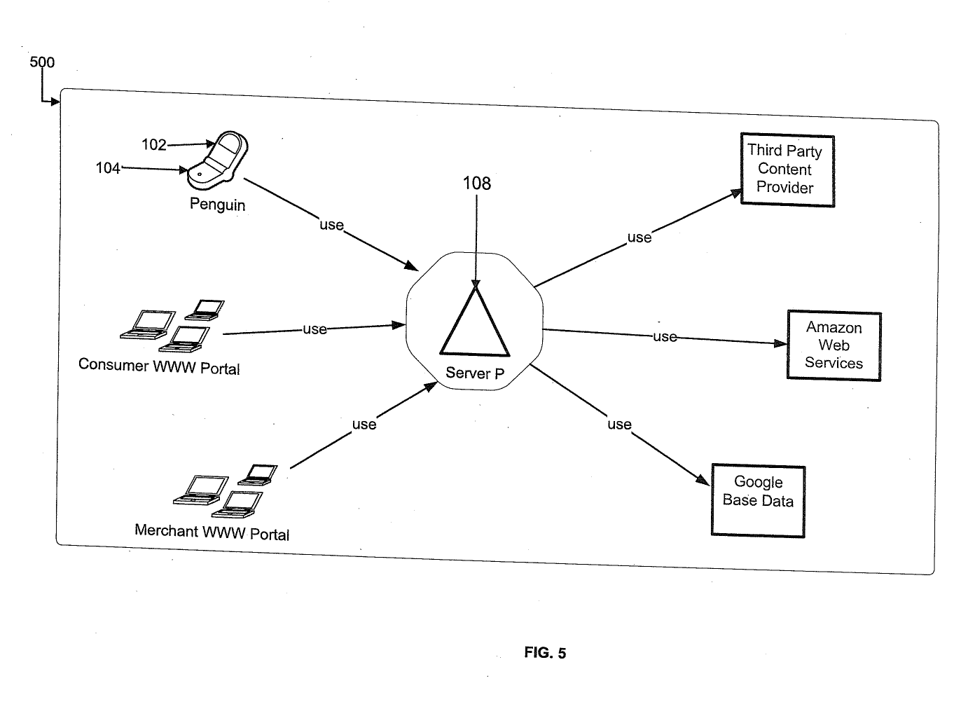

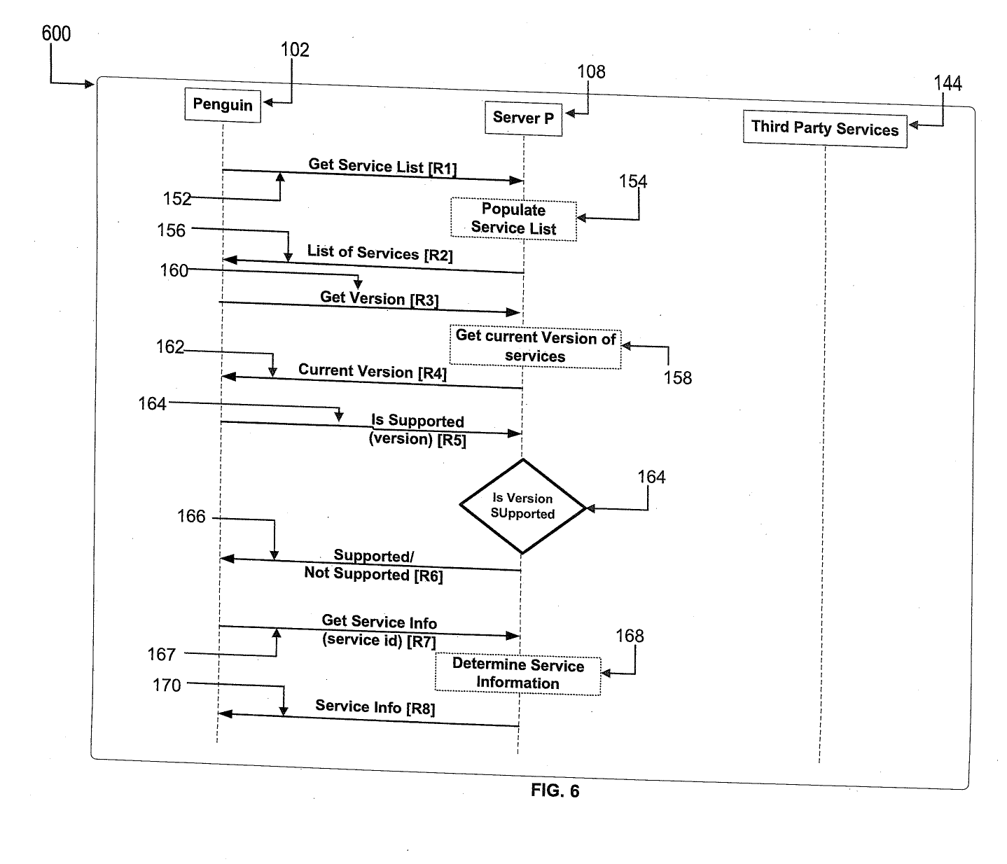

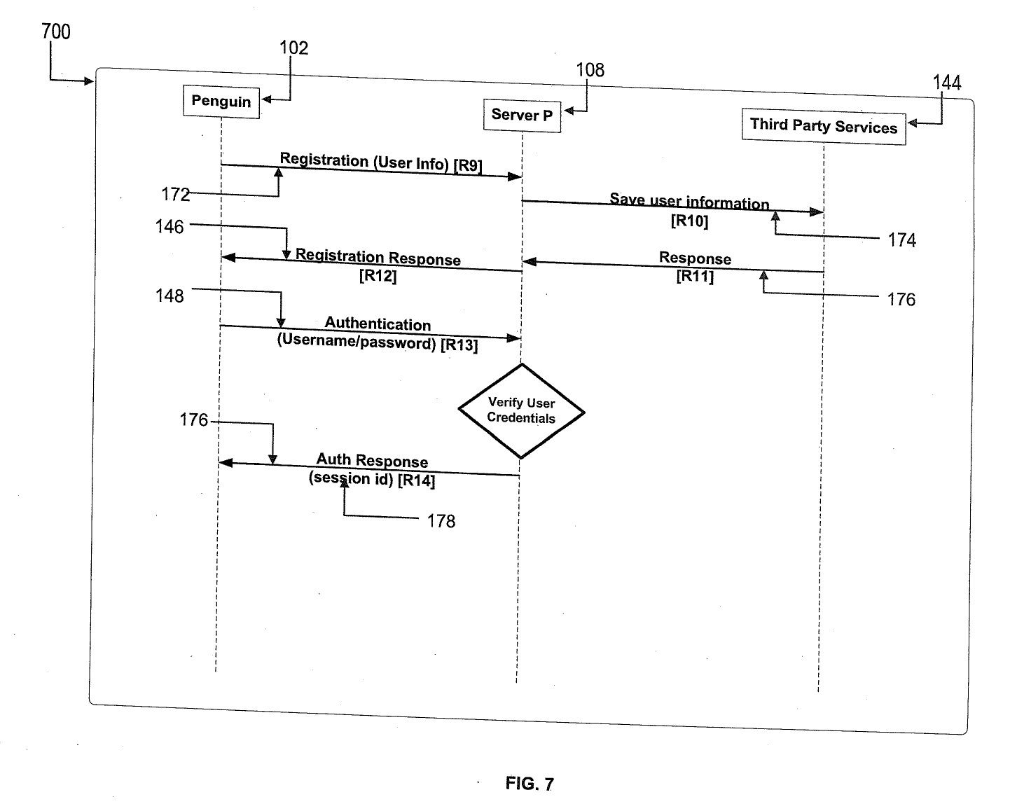

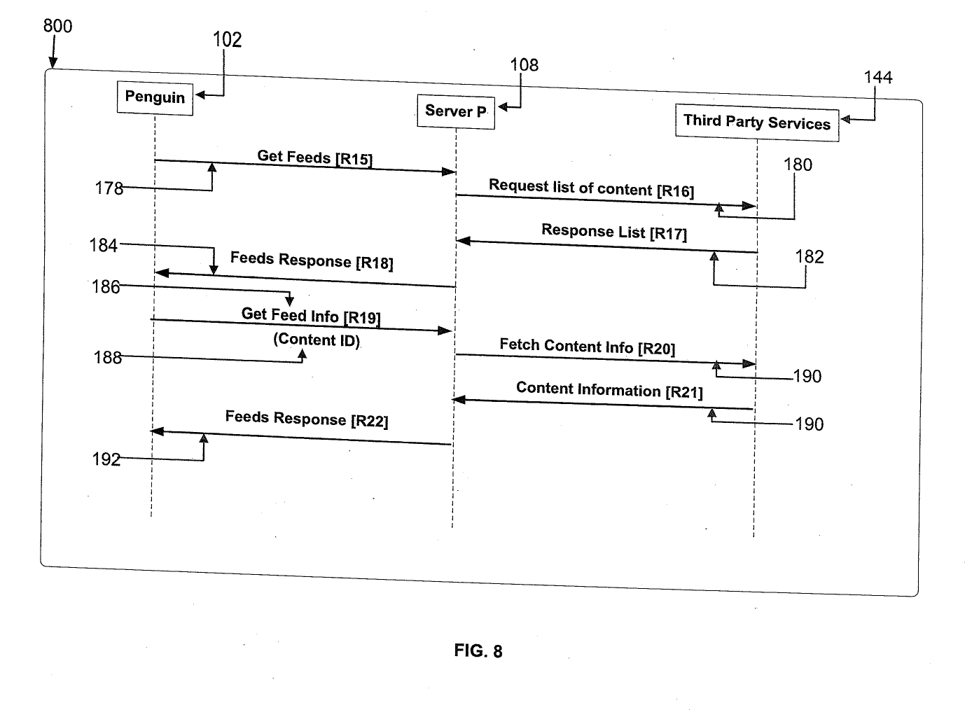

Server P Description and call flows. As shown in the system 500 of FIG. 5, Server P 108 can provide a service infrastructure providing services to mobile device applications 102 (Penguin) and to service and content providers or merchants. Services provided can include a mix of mobile marketing and point of sale services as well as third party services 144. Server P 108 services can include, but are not limited to, consumer registration, consumer account maintenance, and consumer account management. Content management can be another service provided by the Server P. Server P can, in some implementations, use a WWW (World Wide Web) interface for account and content management. The content management can provide a merchant with options for creating and sending coupons and other marketing messages. Third party services can be used for gathering additional content using subscription and procurement of services such as fetching, filtering and storing content. Server P can also distribute content using RSS (Really Simple Syndication) feeds and providing URI (Uniform Resource Identifier). It should be readily understood that RSS is one of the many protocols that can be used to distribute the content. Another function of Server P can be capturing and storing one or more analytics that can include, but are not limited to, consumer purchase preferences, coupon usage statistics and bidding patterns, and the like. Server P can use a Service Oriented Architecture and can have high availability and scalability. FIG. 6, FIG. 7, and FIG. 8 show call flows that in some implementations pertain to service lookup (flows R1→R6), registration 146 and authentication 148 (flows R7→R14), and content delivery (flows R15→R22).

FIG. 6 shows a call flow diagram 600 for service lookup protocols of communication between the mobile device application 102 (Penguin) and Server P 108. Communication can be initiated by the mobile device application 102 (Penguin) by sending a request for the list of services 152 provided by the Server P 108 (R1). The Server P can acknowledge the request, populates the list of services 154 and sends the data back 156 to the mobile device application (Penguin) (R2). A version compatibility check 158 between the mobile device application (Penguin) and Server P can include the mobile device application (Penguin) sending out a request 160 to Server P for the most current version (R3) of services provided by it. Server P can obtain the current version of the services and send the data back 162 to the mobile device application 102 (Penguin) (R4). The mobile device application 102 (Penguin) can then make a check 164 to see if the version of services is compatible with it (R5). If the compatibility check fails, a message can be displayed to the consumer. If the version is supported 166, the mobile device application (Penguin) can send a request for service info 167 (R7). The Server P can determine the service information 168 and sends it back 170 to the mobile device application (Penguin) (R8).

FIG. 7 shows a flow diagram of a call system 700 for registration and authentication services provided by the Server P 108. The first instance of a mobile device application 102 (Penguin) usage can initiate registration of the consumer. The mobile device application (Penguin) can send a registration request 172 (R9) along with the consumer information. Server P can use third party services to save the consumer information 174 as a profile (R10), and an acknowledgement 176 (R11) can be sent back to the Server P. Server P can then send out a registration response 146 (R12) to the mobile device application (Penguin) indicating that the consumer information has been stored and the registration procedure is complete. Subsequent uses of the mobile device application (Penguin) can be followed by consumer authentication 148 in which the mobile device application (Penguin) sends out consumer username and password information (R13) to Server P. The consumer credentials can be checked by the Server P and the authentication response (R14) can be sent back 176 to the mobile device application 102 (Penguin) along with a session identifier 178.

FIG. 8 shows a flow diagram of a call system 800 for content distribution services by Server P 108. The mobile device application 102 (Penguin) can send a request for Feeds 178 (R15). The Server P can contact the third party services and request for the list of content 180 (R16). The third party services can respond by sending a list of content or a response list 182 (R17) to the Server P 108. The server P 108 can feed this response 184 back to the mobile device application 102 (Penguin) (R18). The mobile device application 102 (Penguin) can request the feed information 186 (R19) from Server P 108 by specifying the content ID 188. Server P 102 can then send a request to the third party services 144 to fetch the content info 190 (R20) and the third party service 144 can respond by sending the content information 190 (R21) to Server P 108 which can feed back the response 192 to the mobile device application 102 (Penguin) (R22).

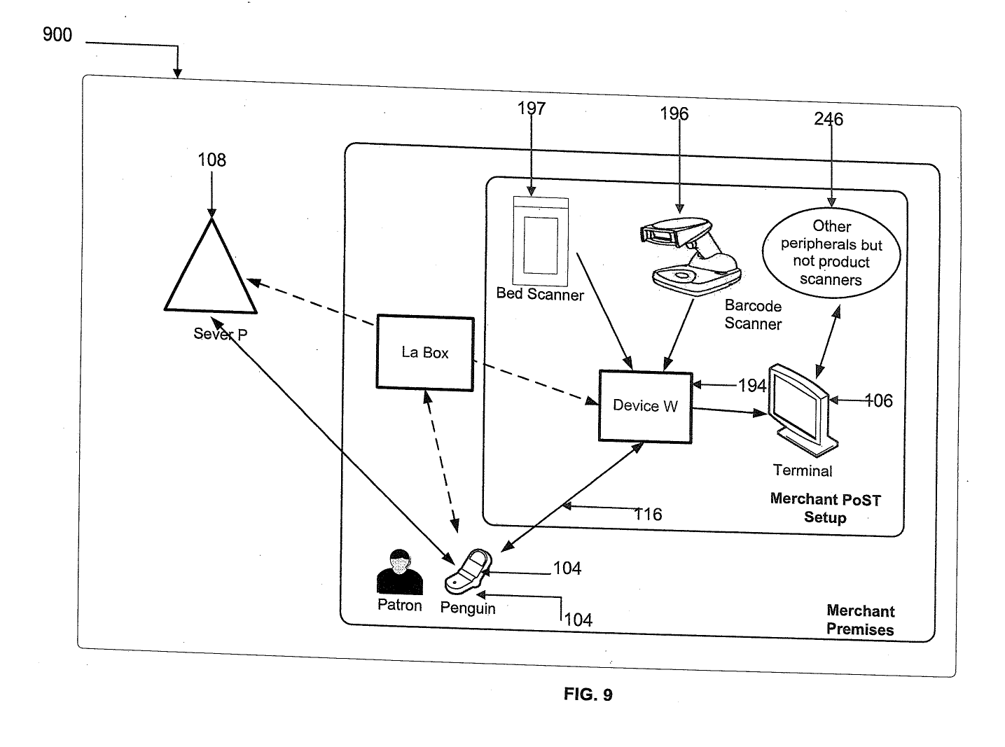

Device W description and Call flows. Device-W is a data acquisition and communication device. It is connected to the host computer as a peripheral device. The overall purpose of Device-W is to collect data from external sources and transfer it to the host computer. It also accepts data from the host computer and transfers it to an endpoint. Device-W also acts as a bridge device between the Point of Sale (PoS) terminal and Internet. It also helps to establish a communication between PoS and user Mobile phone directly or through the common connected network. Device W and PoET can be frame work components which help in delivering a full experience to the consumer. As shown in the system 900, which may be a mobile marketing system or content distribution system, of FIG. 9, Device W 194 can be a combination of a hand-held barcode scanning device 196 and bed scanner 197 incorporating aspects of the current subject matter and an interceptor device placed in between the POS terminal 106 and the bar code scanner. As also seen in FIGS. 21 and 22, device W 194 has the potential to replace existing barcode scanners. Device W can be capable of scanning the barcodes provided by the mobile device application 102 (Penguin). This functionality can provide identification and authentication of users/consumers.

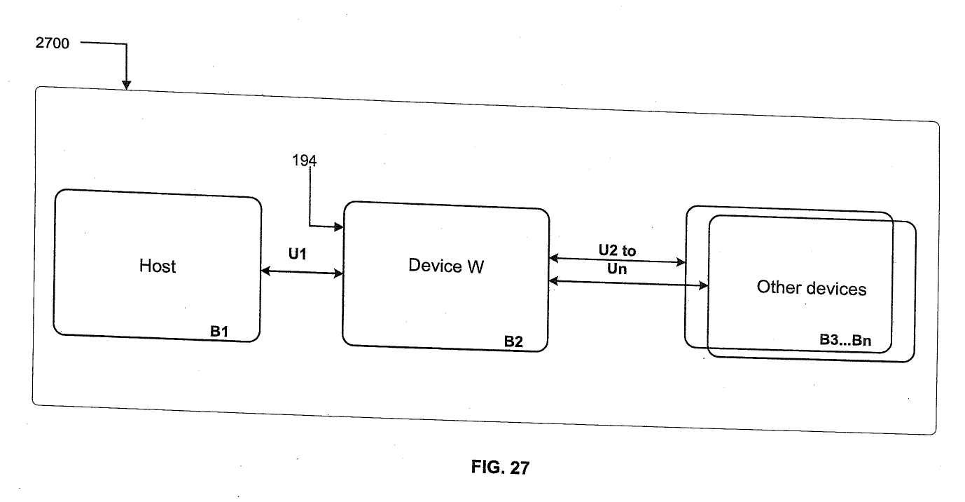

Exemplary architecture of Device-W (A2) 194 is shown in FIG. 27 in a system with Host (A1) and devices (A3 to An). The system architecture is peer-to-peer by design where entities in the system expose services to other peers and consume services from other peers. The interfaces (U1), (U2 to Un) could be wired or wireless. Device-W 194 is expected to be customizable for different applications. These are captured in various Device-W configurations. The interfaces (U1) and (U2 to Un) are bi-directional in nature. The host could be a Point-of-Sale terminal in retail scenarios. As shown in FIG. 23, Device W communicates with mobile devices 104 through a service interface 127 and an optical reader interface 129. Device W communicates with POS terminal 106 through an HID interface device 131 and may have other service interfaces 133.

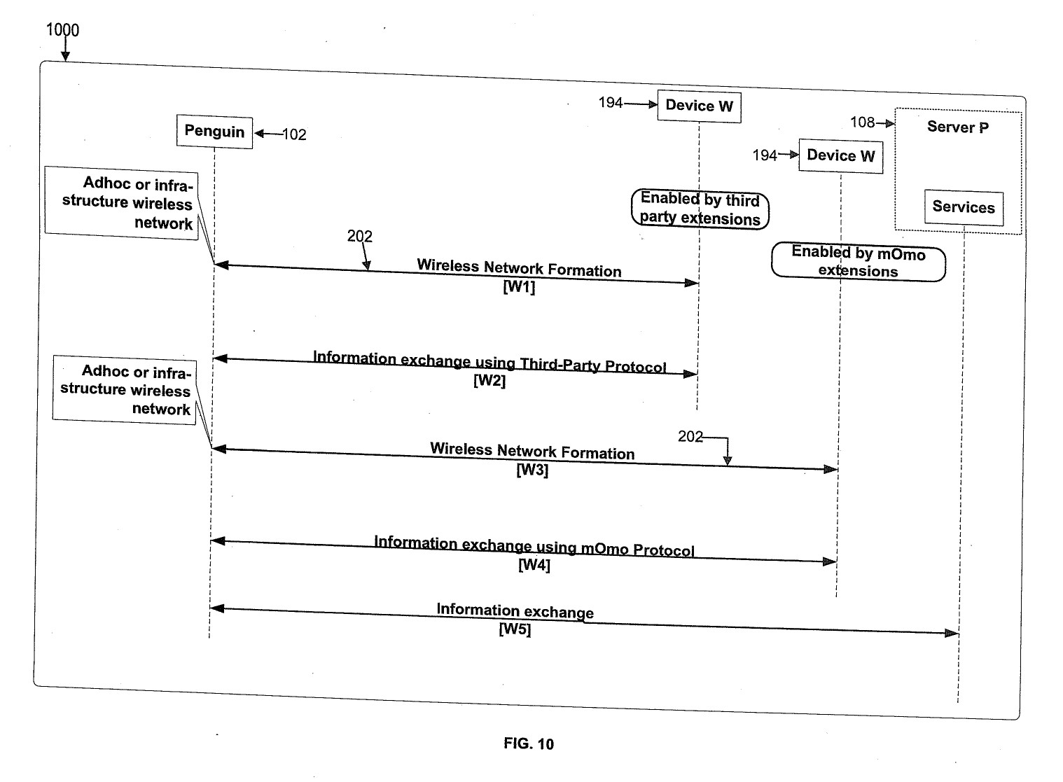

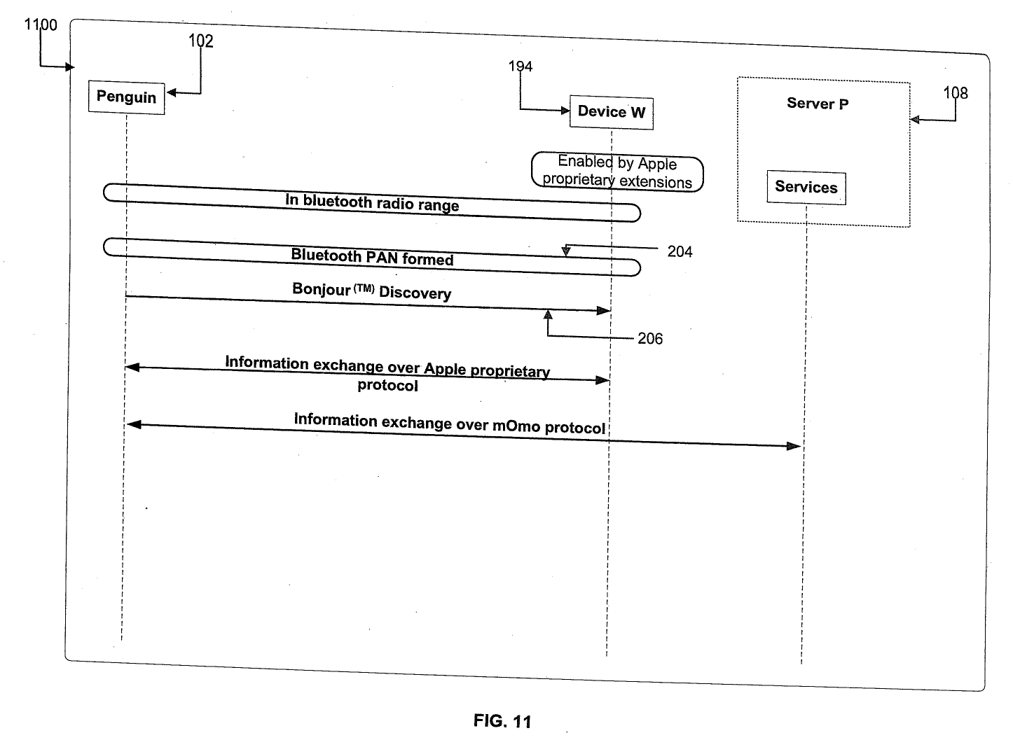

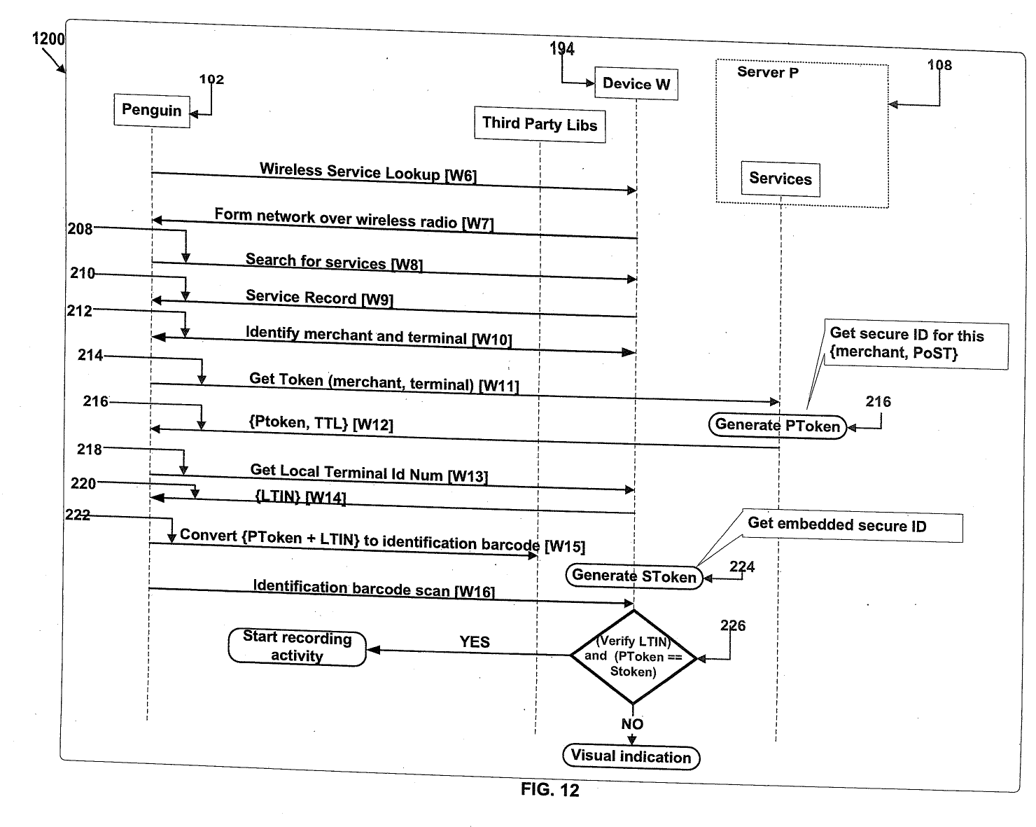

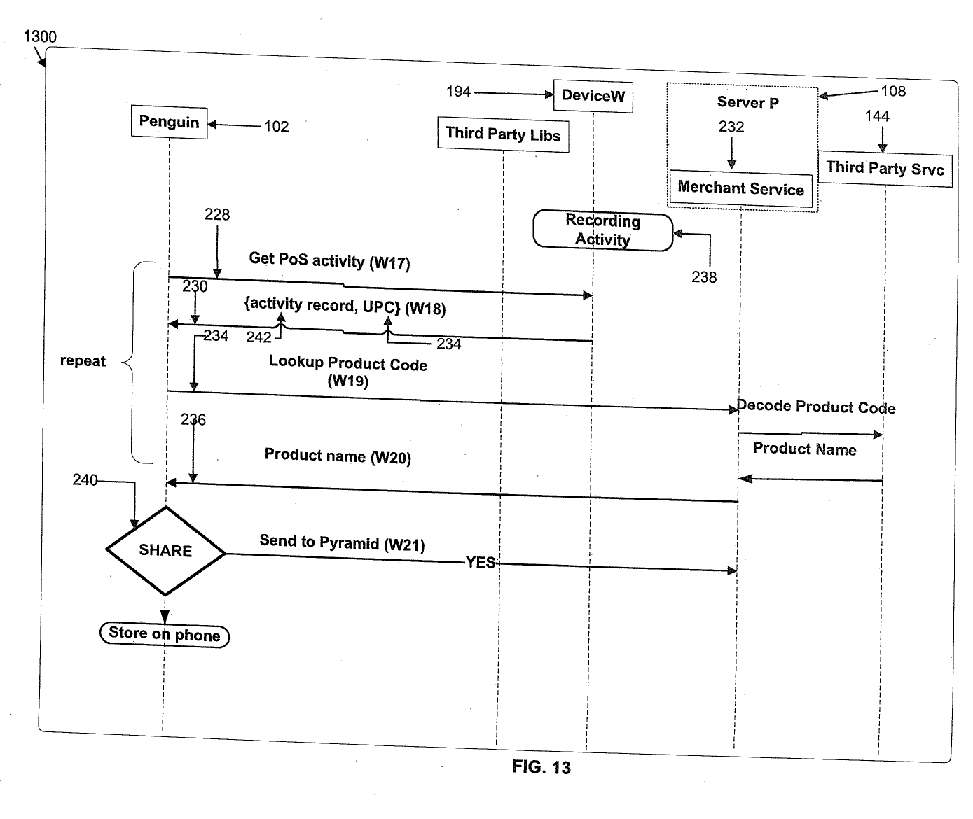

Device W 194 is capable of connecting to the mobile device application 102 (Penguin) and pushing POS terminal activity 116 to the mobile device application 102 (Penguin). Device W 194 is also capable of connecting to Server P 108. The nature of the communication links and how they can be established is discussed in the call flow diagrams of FIG. 10, FIG. 11, FIG. 12, and FIG. 13. These diagrams, described in more detail below, show Device W generic communication flow (W1→W5), identification and authentication of a mobile device application (Penguin) by Device W (W6→W16), transaction capture using pull model (W17→W22), and transaction capture using push mode.

FIG. 10 shows a flow diagram of a call system 1000 illustrating a generic communication module between Penguin 102 and Device W 194 including a step by step description of communication link formation and information exchange between a mobile device application 102 (Penguin) and Device W 194. The mobile device application 102 (Penguin), when in close proximity to a Device W 194, can form a wireless network 202 with the Device W (W1 or W3). This wireless network can be ad hoc, for example a Bluetooth wireless link, or infrastructure based in nature. FIG. 10 describes two different information exchange protocols i.e. W2 and W4. Some smart phones or other mobile communication devices can have proprietary communication protocols. Device W is capable of adhering to such protocols. This will be better illustrated in the FIG. 11 which shows the call flow between a mobile device application (Penguin) and an IPhone. Once the wireless link 202 has been established between the mobile device application 102 (Penguin) and Device W 194, the information exchange takes place using either W2 or W4 depending on the type of phone. Wireless link formation W1 will be followed by information exchange protocol W2 which is established by the third-party based on the type of smart phone. All other wireless link formations, such as for example W3, can be followed by information exchange using a protocol as described herein. In addition to these, the FIG. 10 also shows capabilities of a mobile device application 102 (Penguin) to communicate with the Server P 108 (W5).

FIG. 11 shows a a communication system 1100 illustrating a communication flow between the mobile device application 102 (Penguin) and Device W 194 for an IPhone or other smart phone with similar functionality. A Bluetooth PAN (Personal Area Network) 204 can be formed when the mobile device application (Penguin) 102 is in the proximity of a Device W 194. Bonjour™ 206, or a comparable service on another phone, can then look for devices in the PAN and the services offered by them. Bonjour™, a product of Apple Computer Inc., (Sunnyvale, Calif.) includes a proprietary service discovery protocol feature that is Apple's, an implementation of Zeroconf. Zeroconf is the method of creating a usable IP network without manual intervention). Once Bonjour™ or a comparable program detects the Device W, information exchange can be done over a protocol, which in the case of Bonjour™ and the IPhone, is proprietary.

FIG. 12 shows a call flow diagram for a system 1200 for consumer identification and authentication using Device W. The consumer uses the mobile device application (Penguin) 102 to detect and form a wireless network 202 with Device W 14 (W6 and W7) as explained in the previous call flows. Penguin 102 then issues a search for services 208 (W8) using different Service Discovery Protocols. The Device W, upon receiving the request for services, can send out a Service record 210 (W9). The mobile device application 102 (Penguin) can identify the nearest merchant and POS terminal 212 (W10) and send a request for Token from Server P 214 (W11). Server P 108, upon receiving the request for token 214, generates the PToken 216. The PToken 216 is an authentication code generated by the SecurID™ using a built-in clock and a random key. The RSA SecurID authentication mechanism can include a “token” assigned to a computer user that generates an authentication code at fixed intervals, for example 30 or 60 seconds, using a built-in clock and the card's factory-encoded random key. The token can be a piece of hardware such as a token or USB or software such as a “soft token” for a personal data assistant, cell phone, or other mobile communication device. The random key can also be referred to as a “seed” and can be provided as a *.asc file. The seed is different for each token, and can be loaded into the corresponding RSA SecurID server (RSA Authentication Manager, formerly ACE/Server) as the tokens are purchased. The seed can optionally be 128 bits long. Some RSA SecurID deployments may use varied second rotations, such as 30-second increments.

A consumer authenticating to a network resource, such as for example a dial-in server or a firewall, can be required to enter both a personal identification number and the number being displayed at that moment on their RSA SecurID token. Some systems using RSA SecurID can disregard PIN implementation altogether, and rely on password/RSA SecurID code combinations. The server, which can have a real-time clock and a database of valid cards with the associated seed records, computes what number the token is supposed to be showing at that moment in time, checks it against what the user entered, and makes the decision to allow or deny access. (Reference: http://en.wikipedia.org/wiki/Securid)

The PToken along with the TTL (Time To Live is the expiration time of the PToken) can be sent back to the mobile device application (Penguin) (W12). The mobile device application (Penguin) can send a request 218 to Device W for the Local Terminal Identification Number 220 (W13), which is also known as LTIN. The Device W can respond by sending LTIN 220 to the mobile device application (Penguin) (W14). The mobile device application (Penguin) can use third-party libraries to integrate and convert the PToken 216 and LTIN 220 into a barcode 222 (W15). This identification barcode 222 can be sent back to the mobile device application (Penguin) 102 display interface from where it can be scanned by Device W 194. The Device W 194, meanwhile, generates the SToken 124 using the SecurID embedded within. The SToken is the key against which the identification barcode 222 is matched to make a decision 226 to allow or deny access to Device W 194. If the authentication fails, the failure message can be visually indicated to the consumer via the mobile device application (Penguin). Upon the successful completion of authentication, the Device W can commence recording the transactions.

The transaction capture can done using either a pull model or a push model. FIG. 13 shows a call flow diagram of a communication system 1300 for transaction capture using the pull model. Upon the successful completion of consumer identification and authentication, the Device W can commence recording the POS terminal activity 116. The mobile device application (Penguin) 102, at this juncture, can send a request to Device W 194 for POS activity 228 (W17). The activity is then recorded 238. Device W 194, which may be a SnoopiWand, can respond by sending 230 the activity record 242 along with a summary of the UPC (Universal Product Code) 234 for all the purchases made by the consumer. More detail on scanning and relaying UPC data is shown in FIG. 22. The mobile device application (Penguin) 102 can use the merchant services 232 provided by the Server P 108 to look up the UPC 234 sent by the Device W. The merchant services (part of Server P) use third party services to decode the UPC and send the product description and names 236 to the mobile device application (Penguin) 102 (W20). The pull model can use an algorithm in which in all the steps from W17 to W20 are reiterated in a loop to gather transaction data whenever a validly authenticated consumer performs a transaction at the POS terminal. The transactions can be divided into two categories, one in which the consumer makes use the coupons provided and another in which the purchases are made at the regular price. A clause can be incorporated in a mobile device application (Penguin) “end user license agreement” that the consumer needs to share the data for the purchases made with a coupon.

For the other category, the mobile device application (Penguin), upon receiving the product names, queries the consumer about his or her willingness to share 240 the transaction data. If the consumer agrees to share 240 the data, the transaction data 228 is sent to Server P 108 (W21) where it is stored in a database against the specific consumer profile. If the consumer has reservations about sharing the data, the data is not shared with Server P 108 and is just stored on the phone or other mobile communication device 104 for the consumer to see. Both the categories of data, however, are signed digitally and the digital signature will be verified by Server P to prevent any attempts to hack or modify the data. It should be noted that the mobile communication device could also function as a type of loyalty card at the point-of-sale.

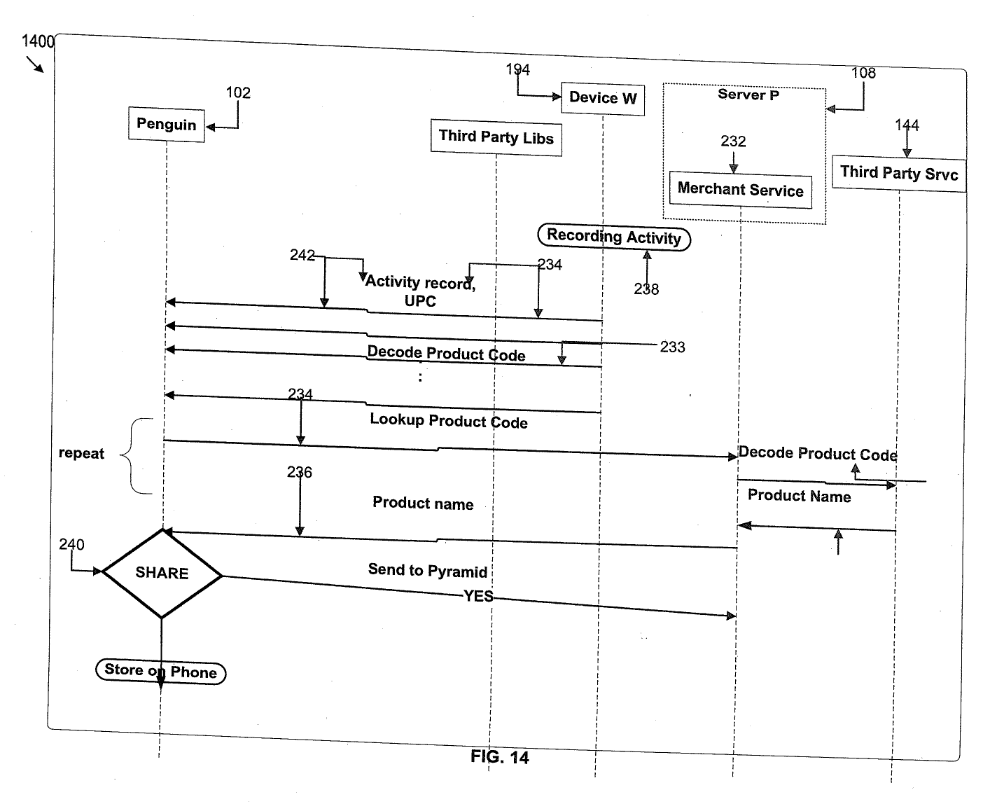

FIG. 14 shows a call flow diagram of a system 1400 for transaction capture using the push model. The primary difference between push and pull models is that in the pull model, Penguin 102 keeps polling Device W 194 for POS transaction data and in the push model, Device W 194 keeps sending the activity record 242 and the UPC data 234 to the mobile device application (Penguin) 102. The only iterative part in the push model is the decoding of the product code 233 using third party services 144 attained by Server P 108. Data, similar to the pull model, is either stored on the phone or shared with Server P based on consumer preference and coupon usage.

Point of Experience terminal (PoET) description. A PoET (Point of Experience Terminal) has functions similar to a POS terminal according to implementations described above. A PoET has the potential to be a single block replacement for the functionalities of both a POS terminal and a Device W. PoET is capable of communicating with Server P with or without the aid of LaBox. PoET provides an unlimited value addition to the business with its varied applications and use cases. Various use cases and applications are enumerated in the PoET infrastructure and system description.

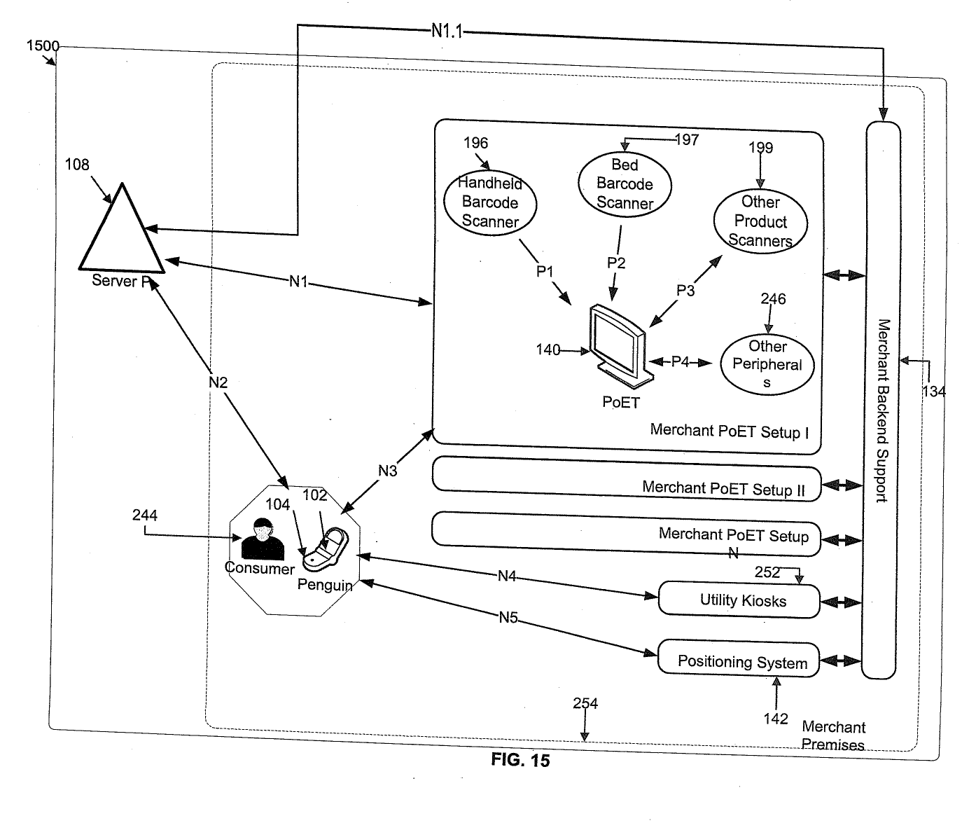

FIG. 15 shows a block diagram of a PoET (Point of Experience Terminal) system 1500 and infrastructure. PoET is aimed at providing a complete consumer 244 and merchant experience without using Device W as an accessory. In the Merchant PoET setup shown in FIG. 15, the PoET 140 interacts with various product scanners and peripherals. The devices with which the PoET 140 interacts can include, but are not limited to, a handheld barcode scanner 196, a bed barcode scanner 197, RFID scanners 199, printers, and modems. The PoET can also interact with other peripherals (also known as checkout hardware 246) such as credit-card transaction systems, cash drawers, receipt printers and pin pads with integrated card swipe.

A PoET 140 is capable of recording transactions upon successful authentication of mobile device application 102 (Penguin) users who are the consumers 244 for the merchant. Point-of-sale activity data 116 can be captured in the mobile device application (Penguin) 102. Upon approval of the consumer 244, these data can be sent to Server P 108 for storage. The data can be sanitized in accordance to set rules and guidelines. Server P 108 and PoET 140 communication can be established over the Internet (N1) or other networks. Server P 108 can also communicate with the merchant backend support 134 (N1.1). The PoET merchant backend support communication can also be established over the Internet or other Wide Area Network if the backend services are not hosted locally on the merchant's computer systems or web site.

The merchant backend support 134 can be provided by one or more of hardware and software, either alone or in combination, thereby increasing the efficiency and utility of the POS manifold. The backend support performs critical functions such as inventory management across geographically dispersed locations, coupon redemption, database maintenance, performing analytics, conduct surveys, sales analysis and staff performance. For example, a restaurant backend support can include all (or at least some) of the restaurant's menu items stored in a database which can be used for many different types of data requests. A grocery merchant can keep track of how much stock he or she has left for each inventory item and how much discount in all was given on a certain product.

Communication between the mobile device application (Penguin) 102 and the Server P 108 can be performed through whatever type of network the mobile device 104 containing the mobile device application (Penguin) 102 is subscribed to. The network can be a cellular data network, WLAN (N2), or the like. The call flow has already been described above in regards to FIG. 6-8. The mobile device application (Penguin) 102 can also be capable of communicating with a PoET (N3) 140. N3 can be established using short-range wireless communication as the link needs to be established only when Penguin is in the proximity of PoET. This can be done, among other possible options, using Bluetooth. The call flows between the mobile device application (Penguin) 102 and a PoET 140 can be similar to the flows between the mobile device application (Penguin) and Device W as a PoET is an enhanced POS terminal with Device W capabilities.

In some implementations, kiosk services 252 can also be accessible by the mobile device application (Penguin) 102 using short range wireless communication modes such as Bluetooth. Kiosk services can provide a wealth of information services to the consumer like product code check, price check, availability of an item etc. The kiosk services can also act as active hosts for the merchants. A fine example would be: being able to personally greet the consumer and delivering product support information depending upon his/her recent purchases. In one example, if a consumer has purchased a new Digital SLR camera, a kiosk can deliver a video to the consumer describing the basics of operating the DSLR camera. The kiosk 252 can also host device manuals which will be easily accessible to the consumer via the mobile device application (Penguin) 102.

In some implementations, the mobile device application (Penguin) 102 can communicate with a positioning system 142 using N5. This link can be established, among other options, using short-range radio communication. The positioning system 142 can play a critical role in consumer profiling within the merchant premises 254. The positioning system 142 can use one or more tracking methods, for example short-range wireless radio optionally assisted by the mobile device application (Penguin) to keep a profile of consumer behavior (movement, pause, presence) within the store premises. The positioning system 142 can be proprietary in nature.

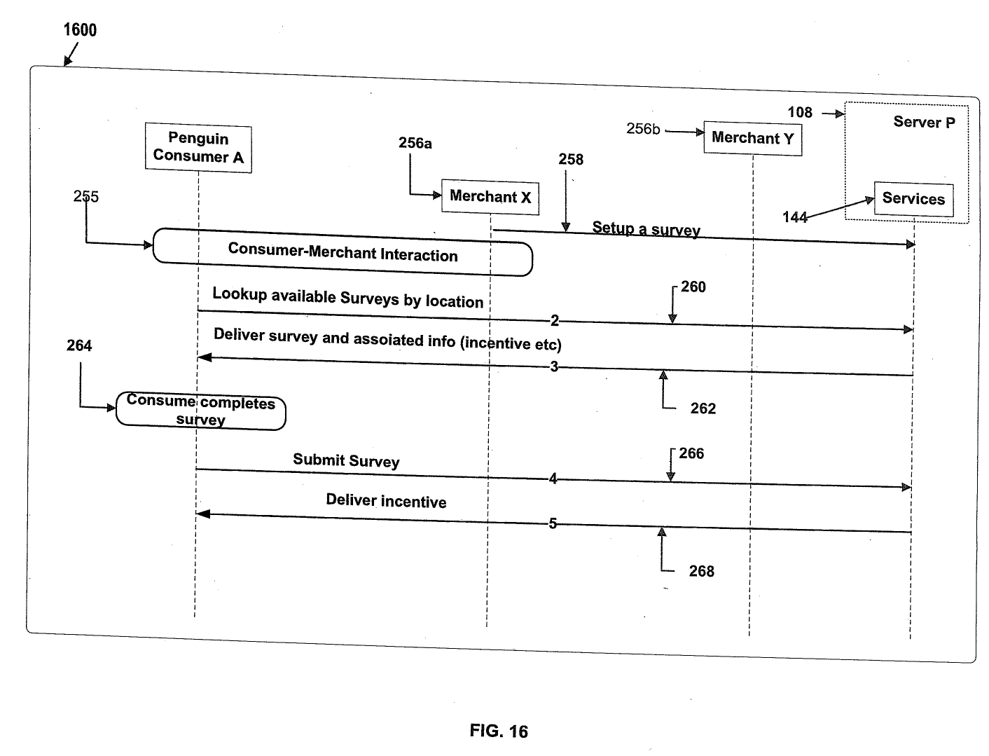

Vertical Applications. FIG. 16 shows a call flow diagram of a communication system 1600 for an example of a vertical application. The vertical application in this example is called “Location Based Survey”. The consumer-merchant interaction 255 can be arranged as discussed in the previous call flows. The use case illustrated in FIG. 16 involves two merchants Merchant X 256a and Merchant Y 256b. Merchant X 246a wants to conduct a survey on customer service, customer assistance and ease of availability of products at his or her store. He or she sets up a survey (1) 258 with the help of the services 144 provided by Server P 108. A consumer mobile device application (Penguin) 102, when in proximity of merchant X 256a, can look up available surveys within the location (2) 260. Server P 108 can respond with a detailed survey and associated incentives 262 with the completion of survey (3). For example, merchant X 256a can promise a discount of 10% on sales over $100 for all customers who complete the survey. Upon completion of the survey 264 by a consumer, the mobile device application (Penguin) 102 can submit the survey 266 to Server P (4) 108. Server P 108, upon receiving the survey, can deliver the incentive 268, for example the 10% discount coupon, to the consumer's mobile device application (Penguin) (5).

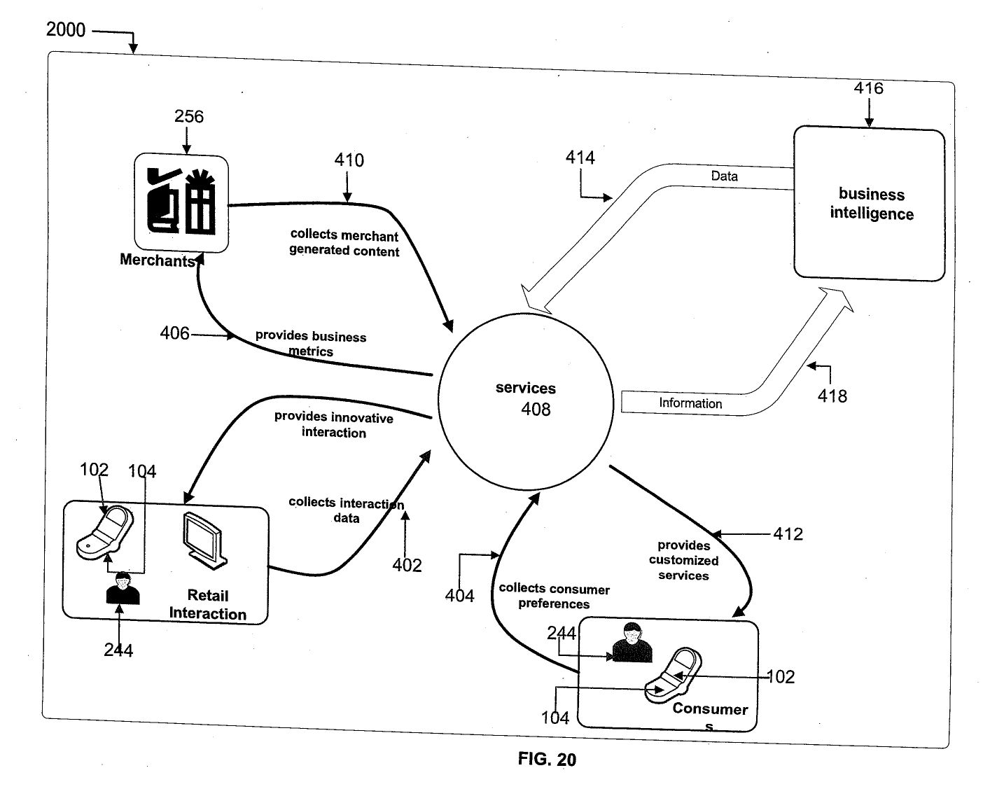

With reference to a business level view shown in FIG. 20, merchants 256 can receive and analyze a host of marketing data through the electronic data capture capabilities of the mobile marketing system 2000. These data include interaction data 402, consumer preferences data 404, and various business metrics 406 from consumers 244. The mobile marketing services, or mOmo 408 also include collecting merchant generated content 410 and providing customized services 412 to consumers 244. All the data 414 collected through mOmo services can be collected as business intelligence 416, and the information 418 circulated and provided to merchants 256.

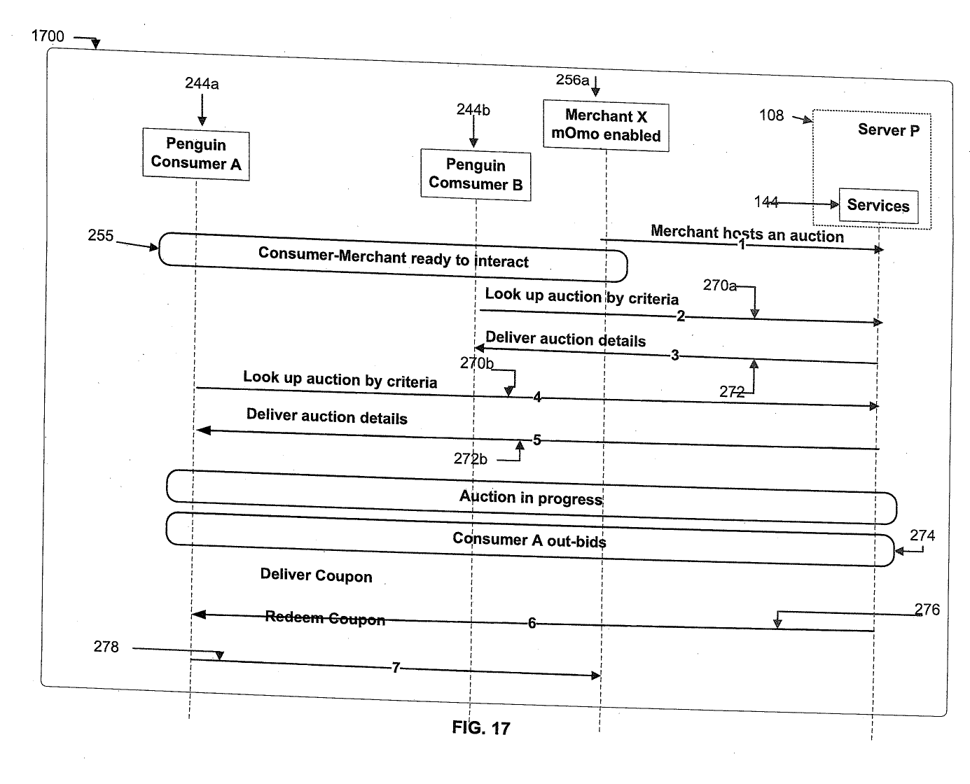

FIG. 17 shows a call flow diagram of a system 1700 for a merchant hosted auction according to an implementation. FIG. 17 shows two consumers 244a, 244b (consumer A and consumer B) in close proximity to merchant X 256a. The customer-merchant interaction 255 can be established, for example using the call flows discussed previously. Merchant X 256a can host an auction on Server P (1) 108. Both of consumers A and B, 244a, 244b, when in proximity of merchant X 256a, can look up an auction by specific criteria 270a, 270b using (2) and (4) respectively. If the criteria match, Server P 108 delivers the auction details 272a, 272b to the mobile device applications (Penguin) of both consumers A and B 244a, 244b using 3 and 5 respectively. After completion of the auction, if one of the consumers wins the auction by outbidding the other 274, a coupon can be delivered 276 to the winner of the auction (6). The winner can redeem the coupon 278 at merchant X (7).

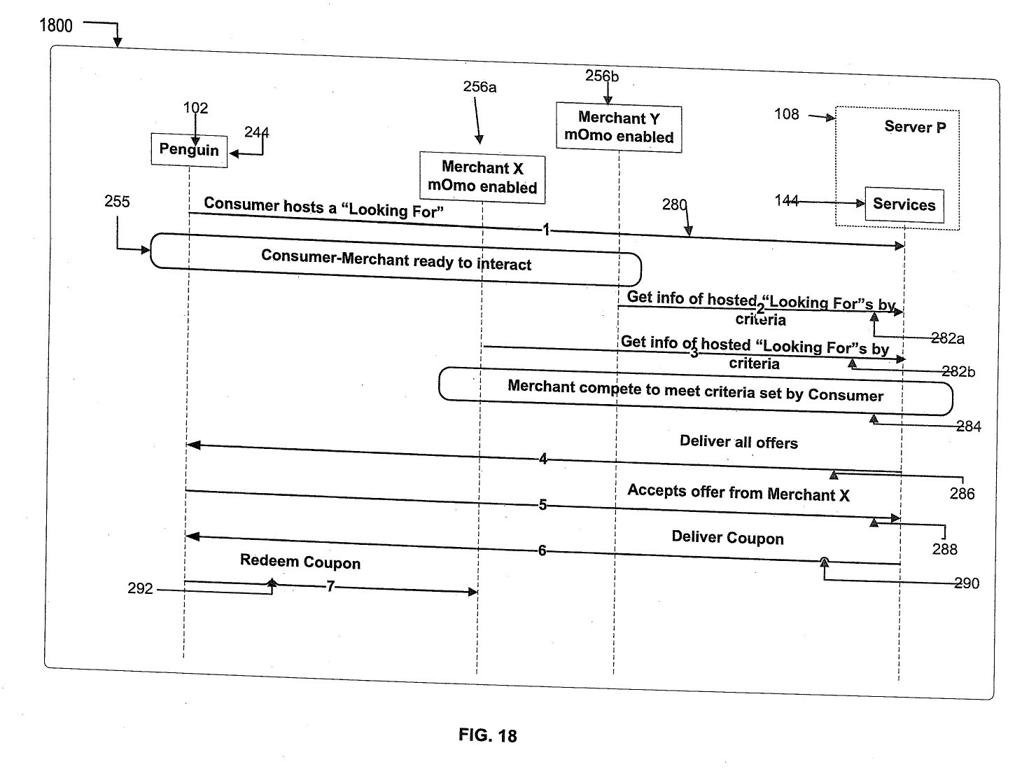

FIG. 18 shows a call flow diagram for consumer hosted “looking for” services 1800. The use case shows a consumer 244 in the proximity of merchants X and Y, 256a, 256b. Using the mobile device application (Penguin) 102 the consumer 244 can send a request 280 to the Server P 108 outlining the description of the product sought as well as a maximum desired price (1). One or more other criteria can also be included. The customer-merchant interaction 255 can be established in using the call flows discussed previously. Both the merchants X and Y 256a, 256b request information 282a, 282b for the hosted product requested by the consumer using (2) and (3) respectively. If the merchants 256a, 256b have the requested product (or service) within the requested price range, they can send relevant offers to Server P 108. The merchants can compete 284 to provide the lowest possible price to the consumer 244. Server P 108 can process all offers associated with the specific request and send them 286 to the consumer's mobile device application (Penguin) (4) 102. The consumer 244 can review the received offers and select one or more of them (5) 288. Server P can deliver a coupon 290 corresponding to the selected offer to the consumer's mobile device application based on the selection (6). The consumer can receive and redeem the coupon 292 with the relevant merchant (7).

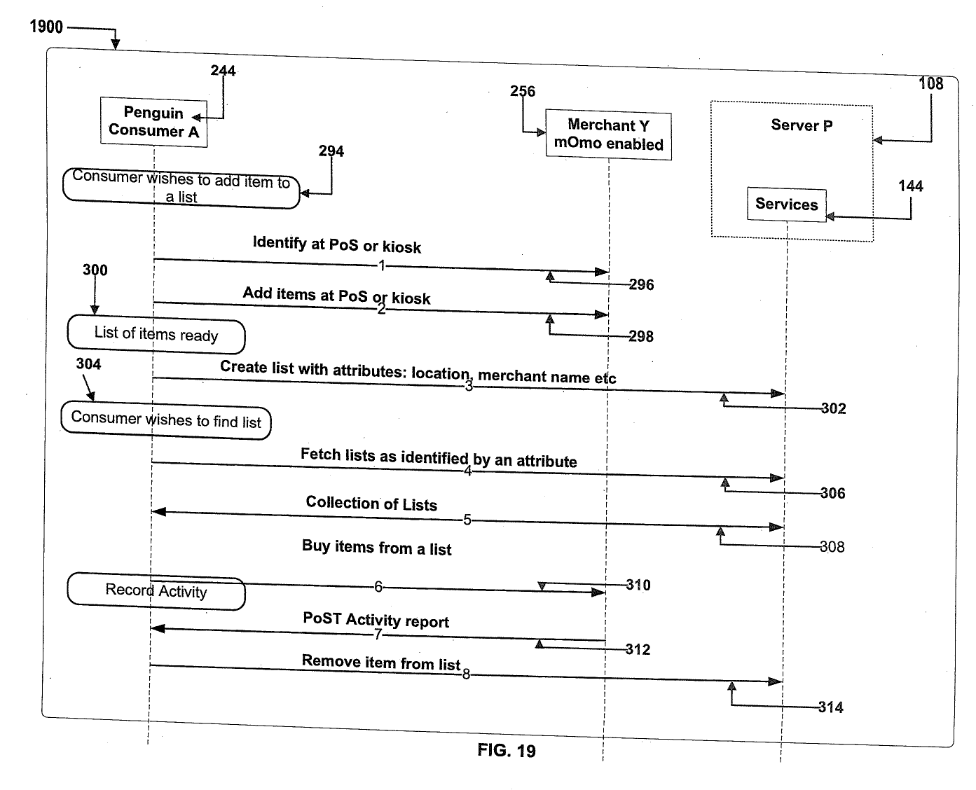

FIG. 19 shows a call flow diagram for a consumer list management service 1900. A consumer 244 can decide to add one or more items to a list 294, and can identify the items at a POS terminal (1) 296. The consumer 244 can add the items to the list at the POS terminal (2) 298. When the list is ready 300, the list can be associated with attributes 302 such as location and merchant name. The list can be sent to Server P (3) 108 to be stored in the consumer's profile. When the consumer wishes to find the list again 304, a request can be sent to Server P 108 to fetch the list according to the attributes 306. The Server P 108 can sort the lists and find the matching list using the input attributes. The collection of lists can be sent 308 to the consumer (5). When the consumer buys items from the list 310 (6), the activity can be recorded 238 and the POS terminal can send 312 the activity report to the consumer 244. The item can then be removed from the list 314 and the updated list can be sent back to Server P 108.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof.

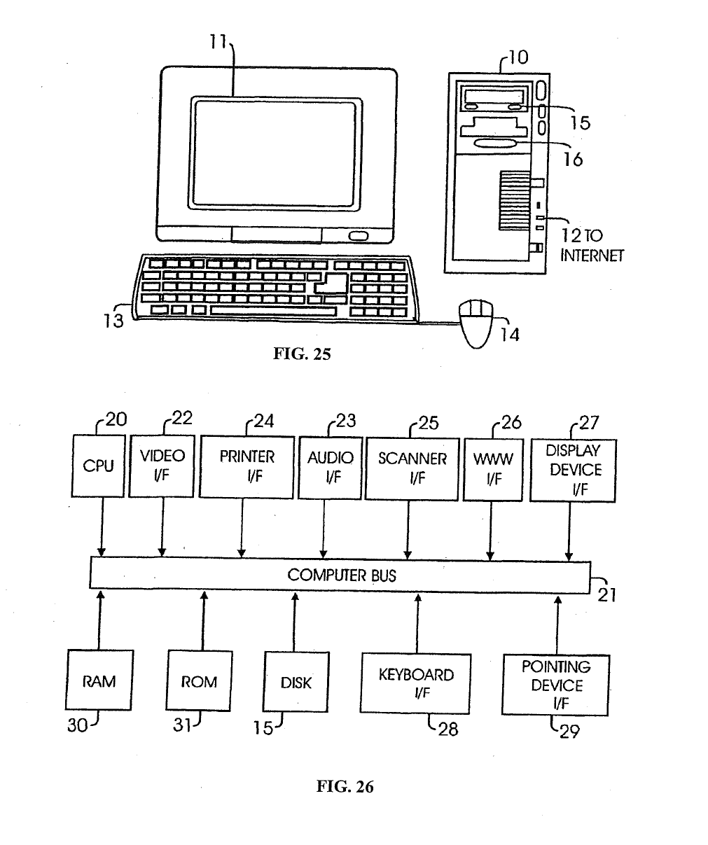

An exemplary embodiment of such of a computing system is illustrated in FIG. 25 and includes a host computer 10 and a monitor 11. To provide for interaction with a user, the subject matter described herein can be communicated via monitor 11, which may be a cathode ray tube (CRT) type, a liquid crystal display (LCD) type, a flat panel type, or any other type of color or monochrome display. The computer 10 has associated accessories such as a keyboard 13 for entering data and user commands, and a pointing device 14, such as a mouse or a trackball, for processing objects displayed on monitor 11. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input.

Computer 10 includes a computer-readable memory medium such as a disk 15 for storing readable data. Besides other programs, disk 15 can store application programs including web browsers by which computer 10 connects to a global computer network, such as the Internet, and the systems described herein.

Computer 10 can also access removable-media 16 (such as floppy disks, compact flash cards, and the like) for storing data files, application program files, and computer executable process steps embodying the present invention or the like via removable-media 16. Removable-media 16 may comprise a digital versatile disc (DVD) (not shown), DVD R/W (read/write) (not shown), compact disc-read only memory (CD-ROM) (not shown), rewritable compact disc (CD R/W) (read/write) device (not shown), and the like. Removable media 16 may be provided with computer 10 to access application program files, stored objects, audio files and data files.

Such a computer system and various implementations thereof can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. Turning to FIG. 26, the internal functional architecture of computer 10 is illustrated. As shown in FIG. 26, computer 10 includes a central processing unit (CPU) 20 for executing computer-executable process steps and interfaces with a computer bus 21. Also shown in FIG. 26 are a video interface 22, an audio interface 23, a printer interface 24, a scanner interface 25, a WWW interface 26, a display device interface 27, a keyboard interface 28, a pointing device interface 29, and disk 15. Audio interface 23 processes audio files and video interface 22 allows a user to access video. Printer interface 24 and scanner interface 25 provide computer 10 with connectivity to a scanner (not shown) and printer (not shown).

As described above, disk 15 stores operating system program files, application program files, web browsers, and other files. Some of these files are stored on disk 15 using an installation program. For example, CPU 20 executes computer-executable process steps of an installation program so that CPU 20 can properly execute an application program. Random access memory (RAM) 30 also interfaces to computer bus 21 to provide CPU 20 with access to memory storage. When executing stored computer-executable process steps from disk 15 (or other storage media such as floppy disk 16, shown in FIG. 25, or network connection 12, shown in FIG. 25), CPU 20 stores and executes the process steps out of RAM 30. Read only memory (ROM) 31 is provided to store invariant instruction sequences such as start-up instruction sequences or basic input/output operating system (BIOS) sequences for operation of keyboard 13 (shown in FIG. 1).

The subject matter described herein can be implemented in a computing system that includes a back-end component, such as for example a data server, or that includes a middleware component, such as for example an application server, or that includes a front-end component, such as for example a client computer having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claim.

1. A mobile marketing system comprising:
a point of sale terminal configured to record data relating to purchasing activity;
a mobile communication device in communication with the point of sale terminal, the mobile communication device containing a mobile device application configured to obtain data containing identifying information relating to a merchant; and
a server providing the data containing identification information and storing the data relating to purchasing activity.

2. The system of claim 1 wherein the point of sale device is a merchant device.

3. The system of claim 2 wherein the mobile communication device contains an identification code, and the merchant device reads the identification code to authenticate a user of the mobile communication device.

4. The system of claim 2 wherein the merchant device scans transaction data including product identification codes purchased by a user and sends the transaction data to the mobile device application.

5. The system of claim 1 wherein the mobile device application prompts a user of the mobile communication device when the user is in proximity of a point of sale terminal

6. The system of claim 2 further comprising integration with a merchant backend server.

7. The system of claim 1 wherein the server provides one or more of: user registration services, user account management services, and content management services.

8. The system of claim 1 wherein the mobile communication device functions as a loyalty card.

9. The system of claim 1 wherein the server captures one or more of: user purchase preference data, coupon usage data, and bidding pattern data.

10. The system of claim 1 further comprising a positioning system in wireless communication with the mobile device application.

11. A content acquisition and distribution system comprising:
one or more scanners;
a point of experience terminal in communication with the one or more scanners, the point of experience terminal authenticating users of a mobile device application, and recording transaction data based upon the point of sale activity data, transmitting the transaction data to data-store, and looking up user loyalty program profile;
a server in communication with the point of experience terminal, the server being configured to store one or more of: the point of sale activity data, the transaction data, and loyalty program data.

12. The system of claim 11 wherein the scanners comprise one or more of: a handheld barcode scanner, a bed barcode scanner, and an RFID scanner.

13. The system of claim 11 wherein the point of experience terminal is in communication with checkout hardware.

14. The system of claim 13 further comprising a helper connectivity or point of presence device in communication with the other system components.

15. The system of claim 11 further comprising integration with a merchant backend support terminal.

16. A method of mobile marketing, comprising:
transmitting a signal containing identification data for a consumer;
authenticating the identification data;
initiating recording of point of sale terminal activity data including purchase data; and
transmitting the point of sale terminal activity data to a mobile device application.

17. The method of claim 16 further comprising transmitting a signal containing data relating to a point of sale terminal in close proximity to a user to the mobile device application.

18. The method of claim 16 further comprising continuously polling a mobile communication device for point of sale terminal activity data.

19. The method of claim 16 further comprising continuously transmitting point of sale terminal activity record to a mobile device application.

20. The system of claim 1 further comprising a point of presence/helper device in wireless communication with the server.
